(19) United States
(12) Patent Application Publication
(10) Pub. No.: US 2026/0217358 A1
(43) Pub. Date: Jul. 30, 2026

(54) RIB STRUCTURE WITH FISHBONE IMITATION ENABLING SHAPE CHANGE IN THE WING VIA THE METHOD OF THE REAR SPAR ROTATION

(71) Applicant: ESKISEHIR TEKNIK ÜNIVERSITESI, Eskisehir (TR)

(72) Inventors: Emre OZBEK, Eskisehir (TR); Selcuk EKICI, Eskisehir (TR); Tahir Hikmet KARAKOC, Eskisehir (TR)

(21) Appl. No.: 19/144,655

(22) PCT Filed: Dec. 15, 2023
(86) PCT No.: PCT/TR2023/051558

§ 371 Date: Jun. 30, 2025

(30) Foreign Application Priority Data
Dec. 30, 2022 (TR) 2022/021698

(51) Int. Cl. B64C 3/48; B64C 3/18

(52) U.S. Cl. CPC B64C 3/48; B64C 3/185; B64C 3/187

(57) ABSTRACT

Disclosed herein is a rib structure, which has a variable design with nature imitation not increasing the weight of the air vehicle, is provided with articulation via the rear spar rotation, and causes no increase in the weight. Also disclosed herein is an air vehicle having a rib structure with fishbone imitation, which minimizes the system weight, provides the application zone flexibility, provides the direction and control authority, and minimizes the cost.

This application is a National Phase entry of International Application No. PCT/TR2023/051558 under § 371 and claims the benefit of Turkish Patent Application No. 2022/021698, filed Dec. 22, 2023, which is hereby incorporated by reference in its entirety.

### FIELD

The present disclosure relates to a rib structure, which is used especially in the air vehicles, has a variable design with nature imitation, is provided with articulation via the rear spar rotation, and causes no increase in the weight.

More specifically, the present disclosure relates to a rib structure where the deformation is provided in the trailing edge by subjecting a rib with fishbone imitation and a rear spar component to the rotation in order to achieve the articulation, said rib structure being able to realize such changes of geometry without adding any extra weight and complexity to the structural units and said rib structure being used especially in the air vehicles.

### BACKGROUND

The simplest flight state for an air vehicle is the straight-symmetrical flight at the fixed altitude. In order to be able to maintain the flight in this state, a lift that is equal to the weight of the air vehicle is required. The aerodynamic lift may be achieved only in case the air vehicle is flying at a certain high speed. As is the case with all the objects moving at high speed through the air, a resistance force (drag) acts on the air vehicle. In order to be able to continue the flight in the same way, the drag should also be equalized by a pull force (or thrust). All of the elements of an air vehicle (such as wing, tail, and body) have positive or negative effects on the lift. However, the lift required by the air vehicle is provided primarily by the wings. Therefore, even the minor changes made in the wing design result in the positive or negative effects on the air vehicle.

The air vehicles are expected to be suitable for all the flight conditions. However, no air vehicle can be suitable for all the conditions. The improved designs, which are suitable only for certain air mission types, are used in the air vehicles. The reason for defining the existing fixed wing air vehicles with the phrase “fixed wing” is that the wings of such air vehicles preserve the geometry at the takeoff during every phase of the flight. The local geometry changes are realized by adding the hinged structures referred to as the control surfaces, such as flap, aileron and slat, to the wings of the fixed wing air vehicles. In this way, it is attempted to approximate “the variable wing” structures of the birds. The designs of the fixed wing aircrafts are intended to enable the phase defined as level flight or cruising flight, which will take most of the flight time, to be realized in the most efficient way. Accordingly, existing designs cause the aircrafts to be planned specially for a single role (e.g., fighter plane, cargo plane, and glider), thus restricting the efficiency of the aircrafts to a single phase. Moreover, these hinged structures in the existing air vehicles increase the inefficiency and the noise emission on the aircraft by forming an air gap. The mechanical, electromechanical or hydromechanical units, which provide the movement of these structures, result in an increase in the labor and cost required for the maintenance. There are studies on the variable wing structures intended to provide a solution for these problems. However, the complexity added by the existing designs to the air vehicle structures and the weights caused by the additional hardware lead to an adverse impact on the aviation industry.

The patent document no. CN110979636A discloses a fishbone type flexible wing structure. The fishbone type flexible wing structure comprises an outer shell with high flexibility, a fishbone structure, a skin support structure, and a deformation drive mechanism. The fishbone structure is made of an elastic material and is connected by means of the ribs to the deformation drive mechanism. The skin support structure is formed by laminating and bonding a plurality of the plate layers and the top surface of the skin support structure is securely connected to the skin with high flexibility. The skin support structure and the fishbone type wing structure are securely connected together. However, the elastic skin structure of the fishbone, which wraps around the pointed ends, is very different from the rib rear portion according to at least one embodiment of the invention.

The patent document no. CN113173243A discloses a piezoelectric fishbone wing structure. The structure comprises a great number of wing portions, which are firmly connected together, and each wing portion includes a drive rib apparatus, a driven rib apparatus, a pull cable drive mechanism, a piezoelectric drive mechanism, and an outer surface structure. The piezoelectric fishbone wing structure disclosed in this document is very different from the rib rear portion according to at least one embodiment of the invention. Since the amount of material used is more than that used in at least one embodiment of the invention, the system weight is increased and this negatively affects the aerodynamic structure of the air vehicle.

Consequently, the existing problems have made it necessary to introduce at least one embodiment of the invention with fishbone imitation, which minimizes the system weight, provides the application zone flexibility, provides the direction and control authority, and minimizes the cost.

### SUMMARY

An object of at least one embodiment of the invention is to provide a rib structure, which is used especially in the air vehicles, has a variable design with nature imitation, is provided with articulation via the rear spar rotation, and causes no increase in the weight.

Another object of at least one embodiment of the invention is to present a rib structure where the deformation is provided in the trailing edge by subjecting a rib with fishbone imitation and a rear spar component to the rotation in order to achieve the articulation, said rib structure being able to realize such changes of geometry without adding any extra weight and complexity to the structural units and said rib structure being used especially in the air vehicles.

Another object of at least one embodiment of the invention is to develop an air vehicle having a rib structure with fishbone imitation, which minimizes the system weight, provides the application zone flexibility, provides the direction and control authority, and minimizes the cost.

At least one embodiment of the invention is a rib used to direct the vehicles with a wing and tail structure wherein said rib comprises, in order to provide the articulation without weight increase, the components of
at least one rib, which is positioned into said wing and has a one-piece structure that decreases in size in the form of a triangle towards one end thereof,
a rib rear portion, which extends from the start of the second zone of said rib towards the end of the rib rear portion by decreasing in size,
at least one front spar, which is configured as a load-bearing structural member, at least one second hole, with which said front spar is connected,
at least one rear spar, which realizes the articulation and has said motor connection,
at least one first hole, with which said rear spar is connected,
at least one first zone, which is positioned between said first hole and the end of the first zone, and
at least one second zone, which is positioned between said first hole and the start of the second zone.

### BRIEF DESCRIPTION OF THE FIGURES

FIG. 1 shows the rib structure according to at least one embodiment of the present invention.

FIG. 2 provides a close-up view of the rib structure according to at least one embodiment of the present invention.

FIG. 3 provides a top view of the air vehicle according to at least one embodiment of the present invention.

FIG. 4 shows the air vehicle according to at least one embodiment of the present invention along with the components motor, front spar, and rear spar. FIG. 5 shows the form of the rib structure according to at least one embodiment of the present invention resulting from the rotation of said rib structure by +90° in the direction of the motor.

FIG. 6 shows the form of the rib structure according to at least one embodiment of the present invention resulting from the rotation of said rib structure by −90° in the direction of the motor.

FIG. 7 provides a top view of the air vehicle according to at least one embodiment of the present invention.

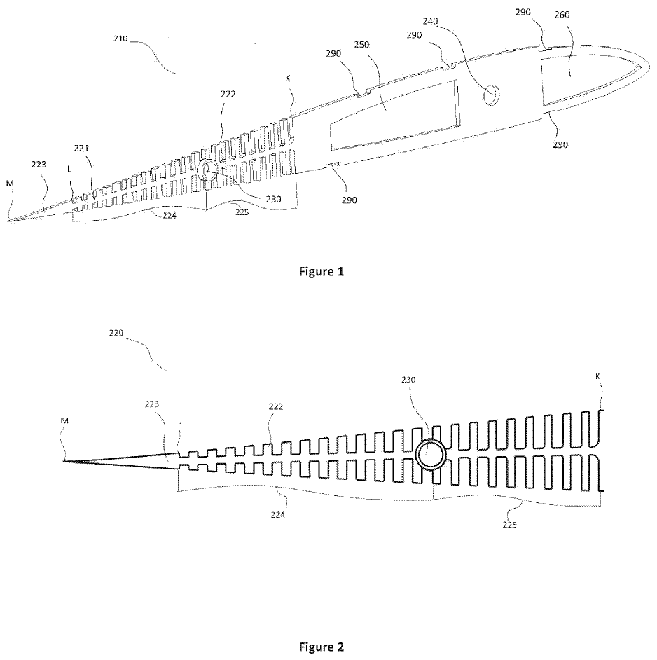

### DETAILED DESCRIPTION

The disclosure relates to a rib (210) structure, which has a variable design with nature imitation not increasing the weight of the air vehicle (10), is provided with articulation via the rear spar rotation, and causes no increase in the weight. The present disclosure also relates to an air vehicle (10) having a rib (210) structure with fishbone imitation, which minimizes the system weight, provides the application zone flexibility, provides the direction and control authority, and minimizes the cost.

The spar of the wing (200) is a type of beam, which is arranged longitudinally with respect to the wing (200) and is the main load-bearing structural member. The spars may be arranged perpendicularly or at a certain angle with respect to the chord line. While some wings have a single spar, the number of spars may also be two or more according to the air vehicle. The lift and the other loads of the wing (200) are transferred to the body (100) by means of the spars and the main connections between the body (100) and the wing (200) are provided via the spars. The ribs (210) are the parts, which are generally perpendicular to the spar and parallel to the chord line and which transmit to the spars the pressure applied by the air current on the leading edge of the wing (200) and the bottom surface of the wing (200) and the lift generated on the top surface of the wing (200) due to the low pressure.

The air vehicle (10) according to at least one embodiment of the invention comprises the components of the body (100), the wing (100), the tail (300), and the motor (400) positioned into said body (100). At least one embodiment of the present invention comprises the components of at least one fixed front spar (270), which is configured as the load-bearing structural member; at least one rear spar (280), in which is the articulation is realized and which has connection with the motor (400) inside the body; and the fixing member (291). Said motor (400) provides the articulation by being placed into said body (100) and by realizing the rotation of said rear spar (280). At least one embodiment of the invention includes the ribs (210), which are positioned into said wing (200) and have a one-piece structure that decreases in size in the form of a triangle towards one end thereof. Said rib (210) has a design similar to a fishbone. Said rib (210) structure basically has the components of a rib rear portion (220), which extends from the start of the second zone (K) of said rib (210) towards the end of the rib rear portion (M) by decreasing in size in the form of a triangle; at least one second hole (240), with which said front spar (270) is connected; at least one first hole (230), with which said rear spar (280) is connected; at least one middle opening (250) and at least one rear opening (260), which are configured to lighten said ribs (210); a recess (290), which provides the connection of said ribs (210) with one another and with said body (100); and a tip (223), which is configured in the form of a triangle after the end of said first zone (L). Said rib rear portion (220) comprises at least one first zone (224), which is positioned between said first hole (230) and the end of the first zone (L); and at least one second zone (225), which is positioned between said first hole (230) and the start of the second zone (K). Said rib rear portion (220) has a structure, which extends from the start of the second zone (K) of said rib (210) towards the end of the rib rear portion (M) by decreasing in size in the form of a triangle. Said rib rear portion (220) has, in its middle section, at least one backbone (221), which extends from the start of the second zone (K) towards the end of the first zone (L). Said first zone (224) and second zone (225) each include at least one protrusion (222) extending to the bottom and top of said backbone (221).

It is possible to increase the number of said protrusions (222) and the protrusions decrease in length towards the end of the first zone (L). By means of the rib (210), which is designed for said wing (200), is similar to a fishbone, and includes the rib rear portion (220), said wing (200) is provided with the ability of being deformed in displacement. While the ribs (210) including the rib rear portion (220) may be manufactured from the thermoplastic materials with high elastic deformation capability, it is also possible to manufacture the same with any composite material exhibiting anisotropic or orthotropic character. Thus, it is possible to choose the material according to the weight of the air vehicle (10), in which it is desired to implement at least one embodiment of the invention.

In another embodiment of the invention, the first zone (224) and the second zone (225) are separated owing to the recesses configured in the lower and upper parts of said first hole (230) and the articulation is realized without said protrusions (222), owing to the recesses and the rear spar (280).

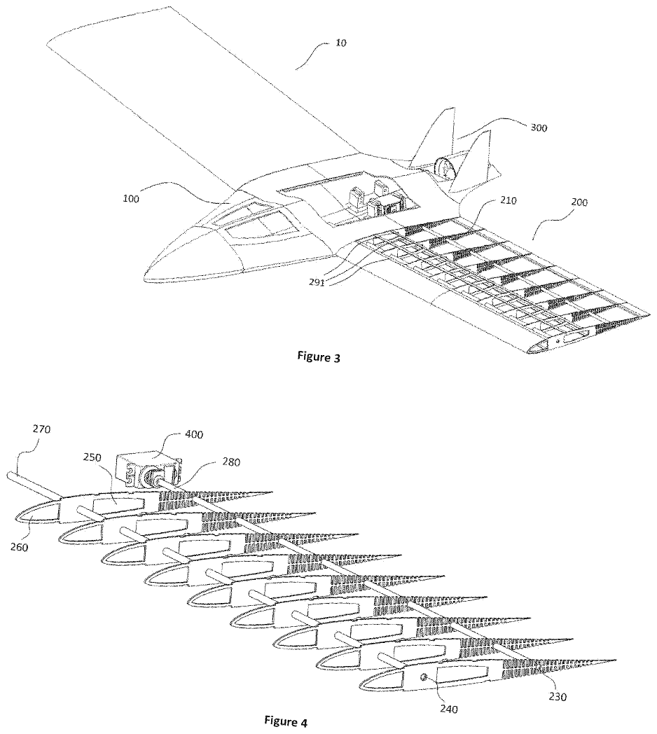

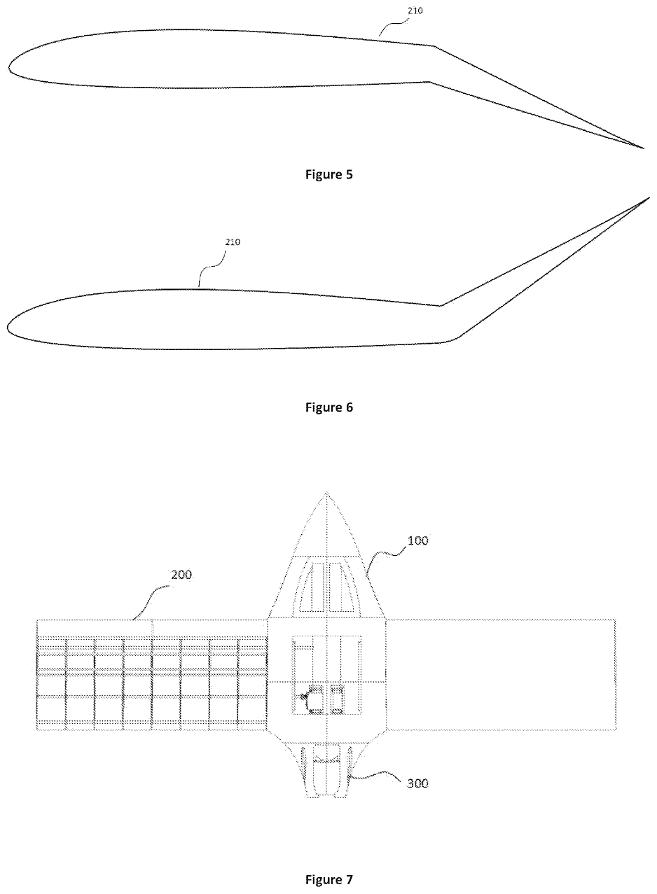

Said first hole (230) is configured between the first zone (224) and the second zone (225) to provide the connection of said rear spar (280), in which the rear spar (280) articulation is realized and which provides the connection of the motor (400) inside the body. The middle opening (250) located in the middle section of said rib (210) structure is preferably configured as a space having a quadrangular structure with one side longer than the other in order to lighten the structure of said wing (200). Said middle opening (250) may also be formed in other geometric shapes such round, square or rectangle. Said second hole (240), which provides the connection of said front spar (270), is configured beside said middle opening (250). Said middle opening (250) is positioned between said rib rear portion (220) and said second hole (240). The rear opening (260), which is configured to lighten said rib (210), is located beside said second hole (240). Said rear opening (260) has a half-cut oval shape. It is also possible to form said rear opening (260) in other geometric shapes such round, square or rectangle. A total of two recesses (290) are present, one in the lower part and the other in the upper part of the side of said rear opening (260) that is near said second hole (240). Moreover, two recesses (290) and one recess (290) are configured respectively in the upper part and lower part of said middle opening (250). Said fixing members (291) are connected via said recesses (290) to enable said ribs (210) to be secured. As shown in FIG. 3, said ribs (210) are arranged inside the wing (200) side by side with spaces left between the same, wherein the rear spar (280) is connected with the first hole (230) of each rib (210) and the front spar (270) is connected with the second hole (240) of each rib (210). The rear spar (280), which is connected via said first hole (230), the articulation of which is realized, and which has connection with the motor (400) inside the body, is subjected to the rotation at a torque value it receives from the motor (400) that includes a mechanical, electromechanical or hydromechanical unit. FIG. 5 shows the form of the rib (210) obtained by the rotation of said rib (210) by +90° in the direction of the motor. When said rear portion (220) rotates by +90° at the torque value received from the motor (400), said rear portion (220) rotates downward from said first hole (230). In other words, while said second zone (225) remains stationary, said first zone (224) rotates downward. FIG. 6 shows the form of the rib (210) obtained by the rotation of said rib (210) by −90° in the direction of the motor. When said rear portion (220) rotates by −90° at the torque value received from the motor (400), said rear portion (220) rotates upward from said first hole (230). In other words, while said second zone (225) remains stationary, said first zone (224) rotates upward. Thus, a structural part articulation is realized.

Since the structure of the motor (400) present inside the body (100) is used according to the state of the art to move the hinged structure in the wing (200) or the tail (300), it does not cause any weight increase. By means of the air vehicle (10) according to at least one embodiment of the invention, the variability of geometry may, unlike the conventional control surfaces, be achieved in a more precise manner during the flight phases. Moreover, by using a narrowing or widening rear spar structure in the wing (200), the amplitude of the geometry change may be managed along the wing (200). Unlike the control surfaces according to the state of the art, said air vehicle (10) developed by at least one embodiment of the invention allows the control movements of the wing (200) structure of said air vehicle (10) to be realized in a “seamless and gap-free” manner from below the surface covering. Thus, the losses and the noise emission caused by the air gaps are minimized. Said design has the potential of improving the efficiency and reducing the noise emissions by way of being integrated into the wings (200), tails (300) and bodies (100) of the air vehicles (10) and into the blades of the helicopters and the wind turbines.

Owing to at least one embodiment of the present invention, the articulation is achieved without adding any extra weight. With the at least one embodiment of the invention, the advantages such as the minimization of the contribution to the system weight, the flexibility of the application zone, the actuator energy cost equivalent to the conventional systems, the absence of an additional financial cost, the scalability, the response time equivalent to the conventional systems, the direction and control authority, and the movement distribution on the wing are obtained.

### REFERENCE NUMERALS IN THE FIGURES

10. Air vehicle
100. Body
200. Wing
210. Rib
220. Rib rear portion
221. Backbone
222. Protrusion
223. Tip
224. First zone
225. Second zone
230. First hole
240. Second hole
250. Middle opening
260. Rear opening
270. Front spar
280. Rear spar
290. Recess
291. Fixing member
300. Tail
400. Motor
K. Start of second zone
L. End of first zone
M. End of rib rear portion

1. A rib used to direct vehicles with a body, wing, tail and motor structure, in order to provide the articulation without weight increase, the rib comprising:
at least one rib, which is positioned into the wing and has a one-piece structure that decreases in size in the form of a triangle towards one end thereof,
a rib rear portion, which extends from a start of the second zone (K) of the rib towards an end of rib rear portion (M) by decreasing in size,
at least one front spar, which is configured as a load-bearing structural member,
at least one second hole, with which the front spar is connected,
at least one rear spar, which realizes the articulation and has a motor connection,
at least one first hole, with which the rear spar is connected,
at least one first zone, which is positioned between the first hole and an end of first zone (L), and
at least one second zone, which is positioned between the first hole and the start of the second zone (K).

2. The rib according to claim 1, wherein the rib comprises, in the middle section of the rib rear portion, at least one backbone, which extends from the start of the second zone (K) towards the end of the first zone (L).

3. The rib according to claim 1, wherein the rib comprises at least one protrusion extending to the bottom and top of the backbone and decreasing in length towards the end of the first zone (L).

4. The rib according to claim 1, wherein the rib comprises at least one middle opening, which is positioned between the rib rear portion and the second hole to lighten the rib.

5. The rib according to claim 1, wherein the rib comprises at least one rear opening which is configured beside the second hole to lighten the rib.

6. The rib according to claim 1, wherein the rib comprises at least one tip, which is configured in the form of a triangle from the end of the first zone (L) towards the end of the rib rear portion (M).

7. The rib according to claim 1, wherein the first zone and second zone are, with the protrusions they include, configured with a structure similar to a fishbone.

8. The rib according to claim 1, wherein the rib rear portion extends from the start of the second zone (K) of the rib towards the end of the rib rear portion (M) by decreasing in size in the form of a triangle.

9. An air vehicle comprising a rib according to claim 1, wherein the air vehicle comprises the components of the body, the wing, the tail, and the motor.

10. The air vehicle according to claim 9, wherein the air vehicle comprises at least one recess, which is configured in the lower and upper parts of the middle opening and the rear opening and which provides the connection of the ribs with one another and with the body.

11. The air vehicle according to claim 9, wherein the air vehicle comprises at least one fixing member, which is connected via the recess to provide the fixation of the ribs with one another and with the body.

12. The air vehicle according to claim 9, wherein the air vehicle comprises the motor component, which is positioned into the body and which provides the articulation by realizing the rotation of the rear spar.
